(19) United States
(12) Patent Application Publication
(10) Pub. No.: US 2014/0006197 A1
(43) Pub. Date: Jan. 2, 2014

(54) ENCODING STAFFING INFORMATION ON RECIEPTS

(71) Applicants: Li Chen, Cary, NC (US); Henri F. Meli, Cary, NC (US); David M. Stecher, Durham, NC (US); Lin Sun, Morrisville, NC (US)

(72) Inventors: Li Chen, Cary, NC (US); Henri F. Meli, Cary, NC (US); David M. Stecher, Durham, NC (US); Lin Sun, Morrisville, NC (US)

(73) Assignee: International Business Machines Corporation, Armonk, NY (US)

(21) Appl. No.: 13/538,791

(22) Filed: Jun. 29, 2012

(51) Int. Cl. G06Q 30/00; G06Q 20/20

(52) U.S. Cl. 705/24; 705/347

(57) ABSTRACT

Systems, methods and computer-readable media facilitate consumer reviews of employees that are on duty at the time a receipt is printed. A code is printed on a receipt provided to the consumer where the code includes data representing the employees that are working when the receipt is printed. A review site receives the data encoded on the receipt. The review site retrieves descriptive data (name, picture, position etc.) for the on-duty employees identified by the code on the receipt. The review site presents the descriptive data along with a review user interface.

### BACKGROUND

Embodiments of the inventive subject matter generally relate to the field of computing systems, and, more particularly, to providing reviews of on-duty staff using information encoded on a receipt.

When consumers are shopping or eating at a restaurant they often want to write a review on a site like Yelp.com to allow other customers to learn from their experience. A primary difficulty in writing these reviews is identifying individual staff members at the store or restaurant during a particular review. Typically the only way to identify staff members where a consumer has had a good or bad experience with is to either remember staff person's name, to look at the name printed on the receipt, or just generally describing the staff person and the time of the transaction. The problems with these approaches are that, it is typically very hard to remember a name for a long time, it is easy to lose a receipt, the receipt typically will only provide the name of the server, not other staff that may have been involved with the transaction, and descriptions are generally too vague to actually identify a particular staff member.

### SUMMARY

Systems, methods and computer-readable media facilitate consumer reviews of employees that are on duty at the time a receipt is printed. A code is printed on a receipt provided to the consumer where the code includes data representing the employees that are working when the receipt is printed. A review site receives the data encoded on the receipt. The review site retrieves descriptive data (name, picture, position etc.) for the on duty employees identified by the code on the receipt. The review site presents the descriptive data along with a review user interface.

### BRIEF DESCRIPTION OF THE DRAWINGS

The present embodiments may be better understood, and numerous objects, features, and advantages made apparent to those skilled in the art by referencing the accompanying drawings.

FIG. 1 is a block diagram illustrating a system for facilitating customer reviews according to embodiments.

FIG. 2 illustrates an example receipt having encoded data on the receipt.

FIG. 3 is a sequence diagram illustrating an example customer purchase scenario in which embodiments of the inventive subject matter may be used.

FIG. 4 is a flowchart illustrating a method for providing customer reviews of store employees.

FIG. 5 depicts an example computer system that may incorporate embodiments.

### DESCRIPTION OF EMBODIMENT(S)

The description that follows includes exemplary systems, methods, techniques, instruction sequences and computer program products that embody techniques of the present inventive subject matter. However, it is understood that the described embodiments may be practiced without these specific details. In other instances, well-known instruction instances, protocols, structures and techniques have not been shown in detail in order not to obfuscate the description.

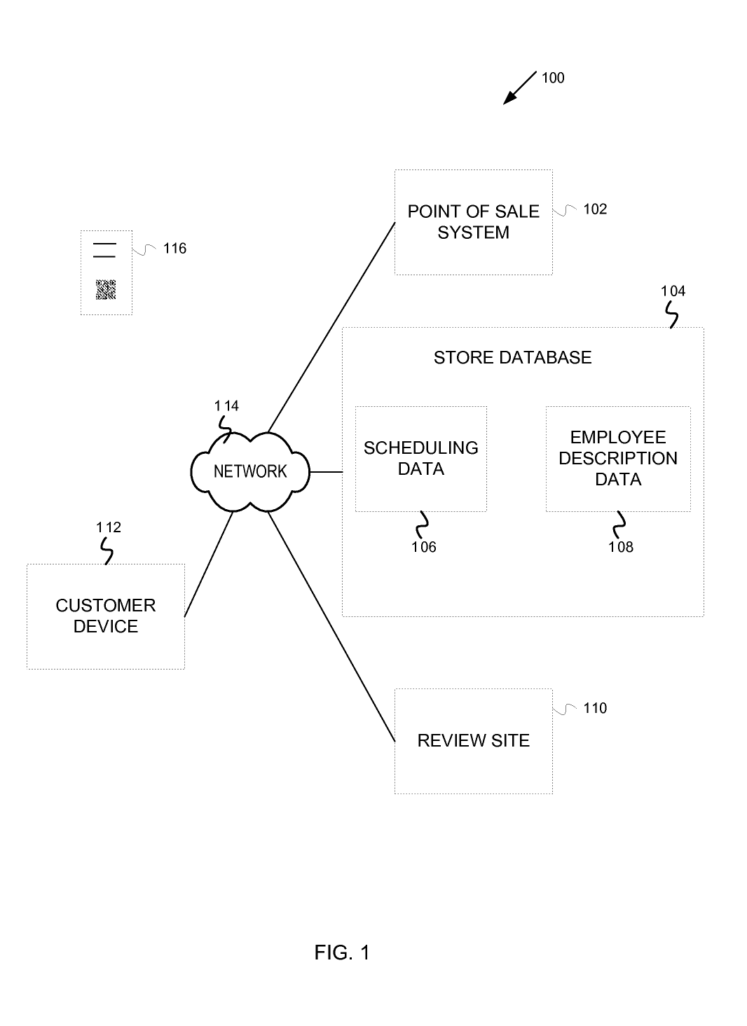

FIG. 1 illustrates a system 100 for facilitating customer reviews according to embodiments. In some embodiments, system 100 includes a point of sale system 102, store database 104, review site 110 and customer device 112, any of which may be communicably coupled via a network 114. Network 114 may be any type of wired or wireless network, including private networks or public networks such as the Internet.

Store database 104 includes information about employees working at a store. It should be noted that as used herein, “store” includes any type of entity providing goods or services, and may include retail stores, restaurants, or service providers. In some embodiments, store database includes scheduling data 106 and employee description data 108. Employee description data 108 includes information that describes a set of employees working at a store. Such information may include the employee name, job title and a digital image of the employee. Employee description data 108 may also include database identifiers uniquely identifying the employee.

Scheduling data 106 includes data indicating whether or not an employee is on-duty. Scheduling data 106 may be maintained in various ways. In some embodiments, scheduling data 106 may be a schedule that is entered or registered by a manager or manager's representative, and comprises the hours that an employee is scheduled to be on duty. In alternative embodiments, scheduling data 106 may be data that is maintained on a real time basis. For example, scheduling data 106 may be updated every time an employee checks in or checks out for work. As a further example, scheduling data 106 may be updated using a geolocation system that automatically determines that the employee is physically present at the store location. For instance, the employees mobile phone may include geolocation software that detects the employee has arrived at the store, and automatically checks the employee in as on-duty upon arrival at the store location, and automatically checks the employee out as off-duty upon departure from the store location.

Point of sale system 102 is used to enter purchase data for a customer and generate a receipt 116 indicating what the customer purchased. Point of sale system 116 retrieves data from store database 104 regarding employees currently on duty at the time receipt 116 is generated. Data that can be used to identify the on-duty employees is encoded on receipt 116.

Customer device 112 can be any type of device capable of scanning codes on receipt 116. In some embodiments, customer device 112 is a mobile phone device configured with a camera and scanning software capable of scanning codes or text on a receipt. Alternatively, customer device 112 may be a tablet computer, personal computer, laptop computer or other device capable of scanning and interpreting codes on a receipt.

Review site 110 comprises a web site that allows users to provide reviews of stores, restaurants, service provides or other business. An example of such a review site is found at the URL (Uniform Resource Locator) www.yelp.com.

Upon scanning a receipt, a customer device 112 decodes the data on the receipt and may invoke browser software that then navigates to a review site 110.

Although shown as a separate entity in FIG. 1, store database 102 may be integrated with other components of system 100. For example, store database may be part of point of sale system 102. Additionally, scheduling data 106 and employee description data 108 may be distributed among different components of system 100. For example, an employer may preregister with a review site and provide employee description data 108 to the review site 110. A store owner or manager may use an interface provided by review site 110 to supply the employee description data 108.

Further details on the operation of system 100 are provided below.

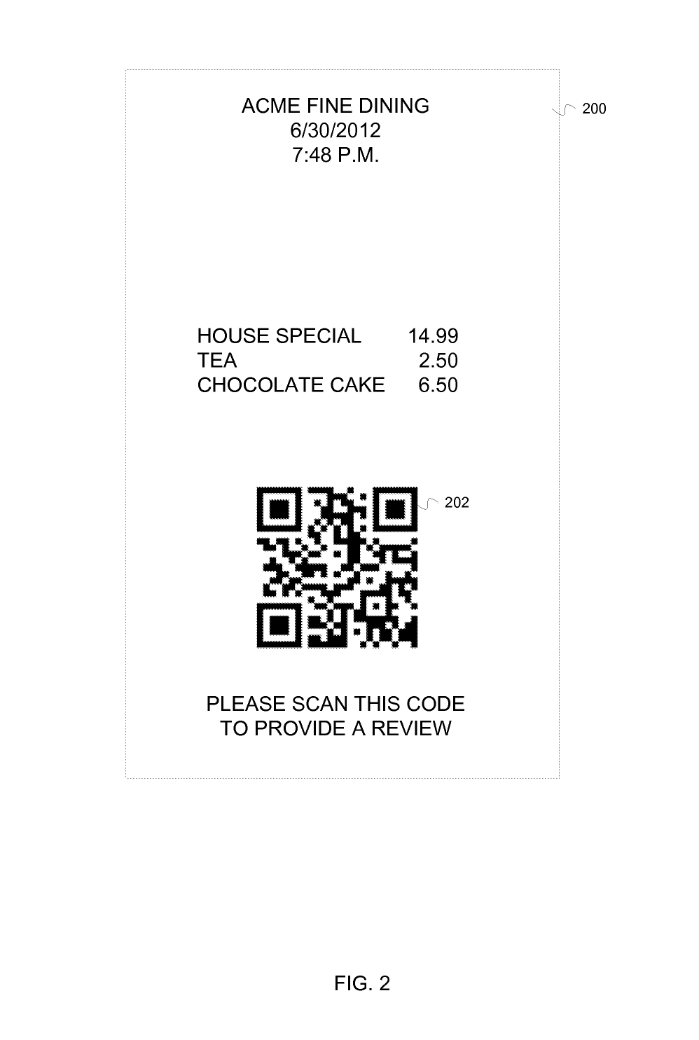

FIG. 2 illustrates an example receipt 200 having encoded data on the receipt. In some embodiments, receipt 200 includes a QR (Quick Response) code 202. As is known in the art, a QR code is a two-dimensional bar code that can store up to 4296 alphanumeric characters. In some embodiments, QR code 202 is encoded with a URL for one or more review sites and information identifying the employees that were on-duty at the time the receipt was printed. The information identifying the on-duty employees may be encoded as part of the URL for the review web site. In some embodiments, such information may include the name of the employee, and may further include the job title of the employee. In alternative embodiments, database identifiers may be used in the URL to identify the on-duty employees.

It should be noted that a QR code is merely one way of encoding information regarding on-duty employees onto a receipt. Those of skill in the art having the benefit of the disclosure will appreciate that other mechanisms to encode data onto a receipt could be used. For example, other types of bar codes or text data can be used to encode data representing on-duty employees onto the receipt. In cases where the bar code can store a limited amount of data, a shift identifier or other group identifier could be used to obtain data for all employees present on the shift or that are a part of the group.

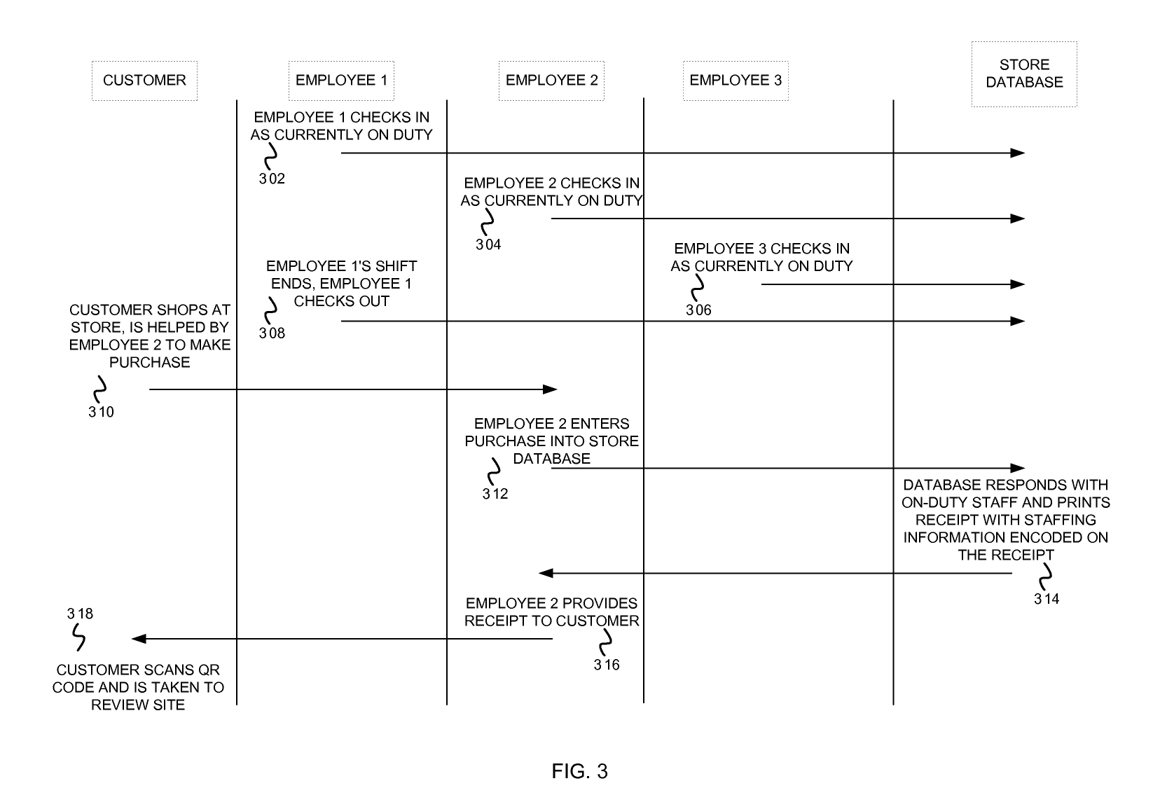

FIG. 3 is a sequence diagram illustrating an example customer purchase scenario in which embodiments of the inventive subject matter may be used. At point 302 in the diagram, employee 1 checks in as currently on duty. As noted above, employee 1 may use a time accounting system to check in. Alternatively, employee 1 may have geolocation software on a mobile device that automatically checks employee 1 in. Further, a RFID tagging system may be used to check in or check out employees.

Later, at point 304, employee 2 checks in as on-duty.

At point 306, employee 3 checks in as on-duty.

Later, at point 308, employee 1's shift ends and employee 1 checks out so that employee 1 is no longer on duty.

At point 310, a customer shops at the store and is assisted by employee 2 during the customer's shopping session. At point 312, employee 2 enters the customer's purchase into the store's database (e.g., through point of sale system 102). At point 314, the store database responds with data regarding the on-duty employees (e.g., employees 2 and 3). The data is encoded on a receipt that is provided to the customer at point 316. In some embodiments, employee 2, the person providing the receipt to the customer, may be identified in the encoded data as the primary representative that interfaced with the customer.

At point 318, the customer scans the receipt. The data encoded on the receipt is used to invoke a browser and navigate to a review web site that provides an interface for the user to review the store and/or employees on duty at the time of the purchase.

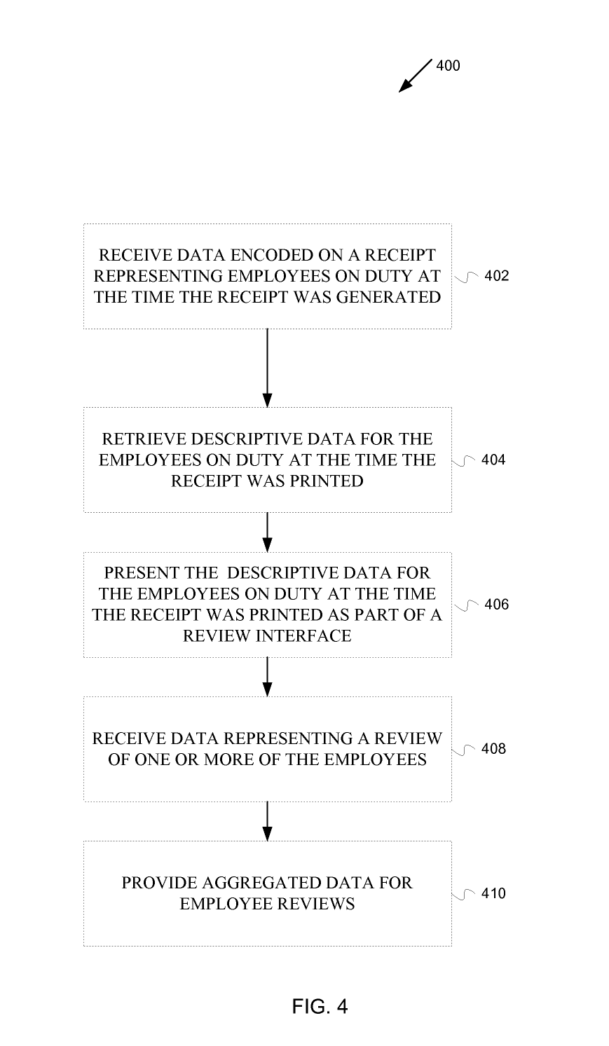

FIG. 4 is a flowchart illustrating a method 400 for providing customer reviews of store employees. The method begins at block 402 by a review site receiving data encoded on a receipt, where the data identifies employees that were on-duty at the time the receipt was printed. As discussed above, the data may use various ways to identify an employee, including names, job titles, unique identifiers, or group identifiers. In some embodiments, the data is supplied as part of a URL that is encoded on a QR code printed on the receipt.

At block 404, the review site retrieves descriptive data for the on-duty employees. The descriptive data may be obtained from the data encoded on the receipt or from a database of employees. The descriptive data may include employee names, job titles and image data of the employee.

At block 406, the descriptive data is presented as part of the user interface for the review web site, along with a review mechanism. For example, the employee's name, job title and picture may be presented along with a “star” rating interface that allows a user to assign a particular number of stars that indicate how satisfied the customer was with the employee. Other rating interfaces, for instance a numeric rating system (e.g., 1-10), could be used and are within the scope of the inventive subject matter.

At block 408, the review site receives the ratings for one or more of the employees on-duty at the time the receipt was generated. The ratings are stored by the review site.

At block 410, the review site may provide aggregated data for a store's employees to management personnel. The data may be aggregated in various ways. For example, in some embodiments, statistical data (mean, median mode etc.) regarding the ratings for a particular employee may be provided. Additionally, a trend line may be presented representing an employee's ratings over time.

The aggregated data may also identify correlations among employees. For example, groups of employees that tend to receive high or low ratings when they are working together may be identified and presented to a user and used to identify groups of employees that work well together and groups that do not work well together. Other correlations may be identified, such as correlation between a time of day, day of week etc. and an employee's rating. Such correlations may identify employees that perform better during day time hours and do not perform well during night time hours or vice versa.

As will be appreciated by one skilled in the art, aspects of the present inventive subject matter may be embodied as a system, method or computer program product. Accordingly, aspects of the present inventive subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present inventive subject matter may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present inventive subject matter may be written in any combination of one or more programming languages, including an object oriented programming language such as Java, Smalltalk, C++or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present inventive subject matter are described with reference to flowchart illustrations and/or block diagrams of methods, apparatus (systems) and computer program products according to embodiments of the inventive subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

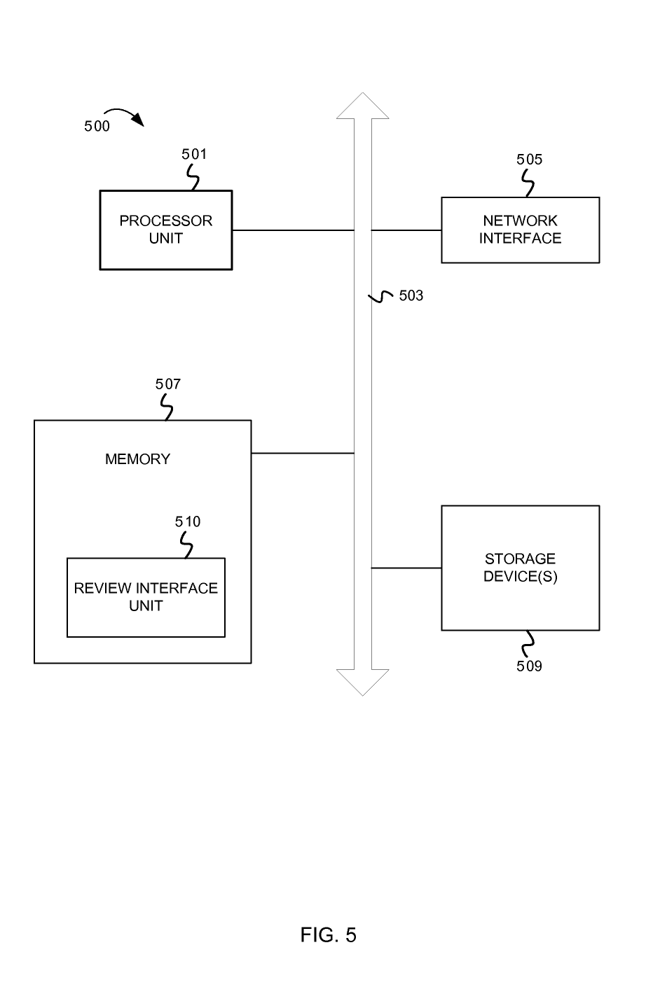

FIG. 5 depicts an example computer system. A computer system includes a processor unit 501 (possibly including multiple processors, multiple cores, multiple nodes, and/or implementing multi-threading, etc.). The computer system includes memory 507. The memory 507 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 503 (e.g., PCI, ISA, PCI-Express, HyperTransport®, InfiniBand®, NuBus, etc.), a network interface 505 (e.g., an ATM interface, an Ethernet interface, a Frame Relay interface, SONET interface, wireless interface, etc.), and a storage device(s) 509 (e.g., optical storage, magnetic storage, etc.). The system memory 507 embodies functionality to implement embodiments described above. The system memory 507 may include a review interface unit 510 that includes functionalities described above that facilitate receiving data encoded on receipts and using the data to provide reviews of employees that were on-duty at the time the receipt was generated. Any one of these functionalities may be partially (or entirely) implemented in hardware and/or on the processing unit 501. For example, the functionality may be implemented with an application specific integrated circuit, in logic implemented in the processing unit 501, in a co-processor on a peripheral device or card, etc. Further, realizations may include fewer or additional components not illustrated in FIG. 5 (e.g., video cards, audio cards, additional network interfaces, peripheral devices, etc.). The processor unit 501, the storage device(s) 509, and the network interface 505 are coupled to the bus 503. Although illustrated as being coupled to the bus 503, the memory 507 may be coupled to the processor unit 501.

While the embodiments are described with reference to various implementations and exploitations, it will be understood that these embodiments are illustrative and that the scope of the inventive subject matter is not limited to them. In general, techniques for providing reviews of employees that were on-duty at the time a receipt is printed as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

1. A method for facilitating reviews, the method comprising:
receiving, by one or more processors, data encoded on a receipt, the data representing a plurality of employees on duty at a time the receipt was generated, the data further including an identification of an online review site;
providing the data representing the plurality of employees to the online review site;
receiving from the online review site descriptive data for the plurality of employees on duty at the time the receipt was generated, the descriptive data received as part of a user interface to provide a review of the plurality of employees on duty at the time the receipt was generated; and
providing data representing a review of one or more of the plurality of employees to the online review site.

2. The method of claim 1, wherein the data encoded on the receipt comprises a QR (Quick Response) code and wherein receiving the data encoded on the receipt comprises receiving the data on a customer device.

3. The method of claim 2, wherein receiving the data on the customer device comprises receiving the data on a mobile phone.

4. The method of claim 1, wherein receiving the data encoded on the receipt comprises receiving employee names for the plurality of employees on duty at the time the receipt was generated.

5. The method of claim 1, wherein receiving the data encoded on the receipt comprises receiving one or more identifiers for the plurality of employees on duty at the time the receipt was generated.

6. (canceled)

7. (canceled)

8. A computer program product for facilitating reviews, the computer program product comprising:
a computer readable storage medium having computer usable program code embodied therewith, the computer usable program code comprising a computer usable program code configured to cause one or more processors to:
receive data encoded on a receipt, the data representing a plurality of employees on duty at a time the receipt was generated, the data further including an identification of an online review site;
provide the data representing the plurality of employees to the online review site;
receive, from the online review site, descriptive data for the plurality of employees on duty at the time the receipt was generated, the descriptive data received as part of a user interface to provide a review of the plurality of employees on duty at the time the receipt was generated; and
provide data representing a review of one or more of the plurality of employees to the online review site.

9. The computer program product of claim 8, wherein the data encoded on the receipt comprises a QR code and wherein the computer usable code configured to receive the data encoded on the receipt further includes computer usable code to receive the data on a customer device.

10. The computer program product of claim 9, wherein the computer usable code configured to receive the data on the customer device comprises computer usable code configured to receive the data on a mobile phone.

11. The computer program product of claim 8, wherein the computer usable code configured to receive the data encoded on the receipt comprises computer usable code configured to receive employee names for the plurality of employees on duty at the time the receipt was generated.

12. The computer program product of claim 8, wherein the computer usable code configured to receive the data encoded on the receipt comprises computer usable code configured to receive one or more identifiers for the plurality of employees on duty at the time the receipt was generated.

13. (canceled)

14. (canceled)

15. A system comprising:
one or more processors; and
a computer readable storage medium having computer usable program code embodied therewith, the computer usable program code comprising a computer usable program code configured to cause the one or more processors to:
receive data encoded on a receipt, the data representing a plurality of employees on duty at a time the receipt was generated, the data included as one or more parameters in a Uniform Resource Locator (URL) for an online review site;
retrieve, by the online review site, descriptive data for the plurality of employees on duty at the time the receipt was generated;
present the descriptive data as part of a user interface to review employees, the review interface identifying the employees on duty at the time the receipt was generated; and
receive data representing a review of one or more of the plurality of employees on duty at the time the receipt was generated.

16. The system of claim 15, wherein the data encoded on the receipt comprises a QR code and wherein the computer usable code configured to receive the data encoded on the receipt further includes computer usable code to receive the data from a customer device.

17. The system of claim 16, wherein the customer device comprises a mobile phone.

18. The system of claim 15, wherein the computer usable code configured to receive the data encoded on the receipt comprises computer usable code configured to receive employee names for the plurality of employees on duty at the time the receipt was generated.

19. The system of claim 15, wherein the computer usable code configured to receive the data encoded on the receipt comprises computer usable code configured to receive one or more identifiers for the plurality of employees on duty at the time the receipt was generated.

20. The system of claim 15, and further comprising a point of sale system, the point of sale system configured to:
receive data indicating one or more employees on duty; and
encode the data into a receipt.

21. The system of claim 15, wherein the computer usable code further comprises computer usable code configured to aggregate review data for one or more employees.

22. The system of claim 21, wherein the computer usable code configured to aggregate review data for the one or more employees includes computer usable code configured to determine correlations within review data for two or more employees of the plurality of employees.

23. The system of claim 22, wherein the computer usable code configured to determine correlations within review data for two or more employees of the plurality of employees includes computer usable code configured to identify a group of two or more employees that receive high ratings when on duty at the same time or low ratings when on duty at the same time.

24. The system of claim 15, wherein the computer usable code further comprises computer usable code configured to identify a correlation between a time of day and a rating for at least one employee of the plurality of employees.
